(19) United States
(12) Patent Application Publication
(10) Pub. No.: US 2024/0198759 A1
(43) Pub. Date: Jun. 20, 2024

(54) AIR VENT OF CAR

(71) Applicant: NIFCO KOREA INC., Asan-si (KR)

(72) Inventor: Jea Yong PARK, Chungcheongnam-do (KR)

(21) Appl. No.: 18/521,136

(22) Filed: Nov. 28, 2023

(30) Foreign Application Priority Data
Dec. 14, 2022 (KR) 10-2022-0175080

(51) Int. Cl. B60H 1/00

(52) U.S. Cl. CPC B60H 1/0065; B60H 1/00028; B60H 2001/00092; B60H 1/00521

(57) ABSTRACT

An air vent of a car includes a horizontal blade installed at a discharge port of a housing and including an upper horizontal blade and a lower horizontal blade, a link having one end coupled to a longitudinal end of the upper horizontal blade and the other end coupled to a longitudinal end of the lower horizontal blade, a plurality of vertical blades rotatably coupled to the housing and arranged at rear of the horizontal blade, an adjustment knob coupled to the upper horizontal blade so as to be movable in a horizontal direction, and a rotation bar coupled to the adjustment knob and connected to the vertical blades.

### CROSS-REFERENCE TO RELATED APPLICATION

This application is based upon and claims the benefit of priority from Korean Patent Application No. 10-2022-0175080, filed on Dec. 14, 2022, the entire contents of which are incorporated herein by reference.

### TECHNICAL FIELD

The present disclosure relates to an air vent of a car.

### BACKGROUND

A motor vehicle includes an air conditioning system in which an air conditioner and a heater are installed to circulate and purify indoor air or maintain a temperature inside the motor vehicle. The air conditioning system includes an air duct that provides an air flow passage. An air vent connected to an outlet of the air duct is provided on a panel installed inside the motor vehicle. The air vent is configured such that a direction of a wind discharged through the air vent can be adjusted as intended by a driver or a passenger.

The conventional air vent of a car 10 shown in FIG. 1 may include a housing 11 defining an air passage, a horizontal blade 12 installed at an outlet side of the air passage, a plurality of vertical blades 13 arranged at the rear of the horizontal blade 12, and an adjustment knob 14 coupled to the horizontal blade 12 so as to be movable in the horizontal direction.

When a vehicle occupant moves the adjustment knob 14 to the left or right, the vertical blades 13 are rotated toward the left or right. As a result, the direction of the wind discharged through a discharge port 10a of the housing 11 is adjusted to the left and right. When the vehicle occupant moves the adjustment knob 14 upward or downward, the horizontal blade 12 is rotated upward or downward. As a result, the direction of the wind discharged through the discharge port 10a of the housing 11 is adjusted upward or downward.

In the conventional air vent 10 of a car, it is difficult to effectively adjust the wind direction in an intended direction because the horizontal blade 12 for adjusting the wind direction in the vertical direction is located at the center of the discharge port 10a. For example, referring to FIG. 2, when the horizontal blade 12 rotates counterclockwise, the direction of a wind f1 passing through the central portion of the air passage is changed upward by the horizontal blade 12. However, a wind f2 or f3 passing through the region A or B near the top or bottom of the air passage passes through the discharge port 10a without passing through the horizontal blade 12. Therefore, the wind direction may not be changed, or the degree of change may be small. Accordingly, the conventional air vent 10 has a problem in that the wind direction is not sufficiently changed in the vertical direction even if the adjustment knob 14 is adjusted in the vertical direction.

### SUMMARY

Various embodiments of the present disclosure provide an air vent of a car capable of effectively adjusting a wind direction up and down.

An air vent of a car according to one embodiment of the present disclosure may include: a horizontal blade installed at a discharge port of a housing and including an upper horizontal blade and a lower horizontal blade; a link having one end coupled to a longitudinal end of the upper horizontal blade and the other end coupled to a longitudinal end of the lower horizontal blade; a plurality of vertical blades rotatably coupled to the housing and arranged at rear of the horizontal blade; an adjustment knob coupled to the upper horizontal blade so as to be movable in a horizontal direction; and a rotation bar coupled to the adjustment knob and connected to the vertical blades.

In one embodiment, the adjustment knob may include an insertion portion protruding upward, and the upper horizontal blade may include an insertion groove formed at a lower portion of the upper horizontal blade and accommodating the insertion portion.

In one embodiment, the insertion portion may include a locking hook, and the upper horizontal blade may include a locking protrusion to which the locking hook is configured to be locked.

In one embodiment, the air vent of a car may further include: a vane bracket coupled to the upper horizontal blade and configured to prevent the insertion portion from being separated from the insertion groove.

In one embodiment, the upper horizontal blade may include an upper blade portion extending from a front end of the upper horizontal blade to a rear end of the upper horizontal blade and an upper blocking portion extending upward from the rear end of the upper blade portion, and the lower horizontal blade may include a lower blade portion extending from a front end of the lower horizontal blade to a rear end of the lower horizontal blade and a lower blocking portion extending downward from the rear end of the lower blade portion.

In one embodiment, the air vent of car may further include an elastic body formed in the insertion portion and coupled to an accommodation groove opened upward, wherein the elastic body may have an upper surface in contact with a surface defining the insertion groove.

### BRIEF DESCRIPTION OF DRAWINGS

The accompanying drawings, which are incorporated in and constitute a part of the specification, illustrate embodiments of the present disclosure.

FIG. 1 is a front view of a conventional air vent of a car.

FIG. 2 is a cross-sectional view of the conventional air vent of a car taken along line I-I′ in FIG. 1.

FIG. 3 is a front view of an air vent of a car according to an embodiment of the present disclosure.

FIG. 4 is a perspective view of the air vent of a car according to an embodiment of the present disclosure.

FIG. 5 shows an internal configuration of a housing of the air vent of a car shown in FIG. 4.

FIG. 6 is a cross-sectional perspective view of the air vent of a car taken along line II-II′ in FIG. 5.

FIG. 7 is a rear perspective view of a horizontal blade according to an embodiment of the present disclosure.

FIG. 8 is an exploded perspective view of the horizontal blade equipped with an adjustment knob according to an embodiment of the present disclosure.

FIG. 9 is a cross-sectional perspective view of the horizontal blade taken along line III-III′ in FIG. 7.

FIG. 10 shows a movement of vertical blades caused by sliding of the adjustment knob according to an embodiment of the present disclosure.

FIG. 11 shows a posture of the horizontal blade and an air flow when the adjustment knob according to an embodiment of the present disclosure is moved upward.

FIG. 12 shows the posture of the horizontal blade and an air flow when the adjustment knob according to an embodiment of the present disclosure is moved downward.

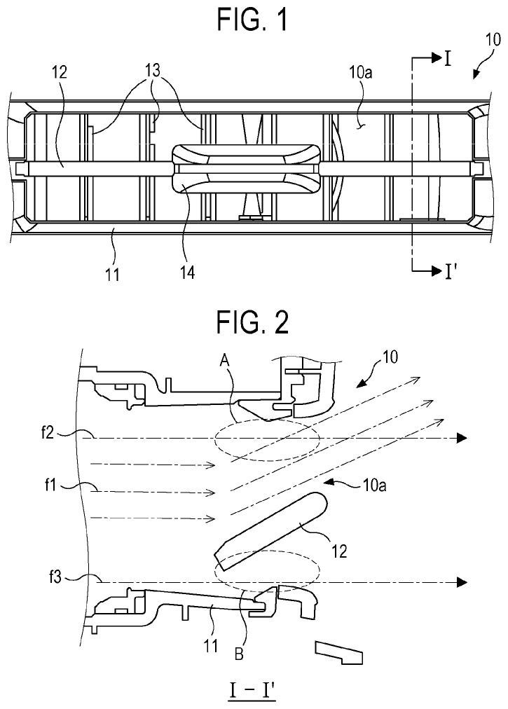

### DETAILED DESCRIPTION

Reference will now be made in detail to various embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

All the technical terms and scientific terms in the present disclosure include meanings or definitions that are commonly understood by those of ordinary skill in the art unless otherwise defined. All terms in the present disclosure are selected for the purpose of describing the present disclosure more clearly, and are not selected to limit the scope of the present disclosure.

As used in the present disclosure, expressions such as “comprising,” “including,” “having,” and the like are to be understood as open-ended terms having the possibility of encompassing other embodiments, unless otherwise mentioned in the phrase or sentence containing such expressions.

Singular expressions that are described in the present disclosure may encompass plural expressions unless otherwise stated, which will also be applied to the singular expressions recited in the claims.

Hereinafter, the embodiments of the present disclosure will be described in detail with reference to the accompanying drawings. The same reference numeral will be used for the same element throughout the drawings, and a duplicate description of the same element will be omitted.

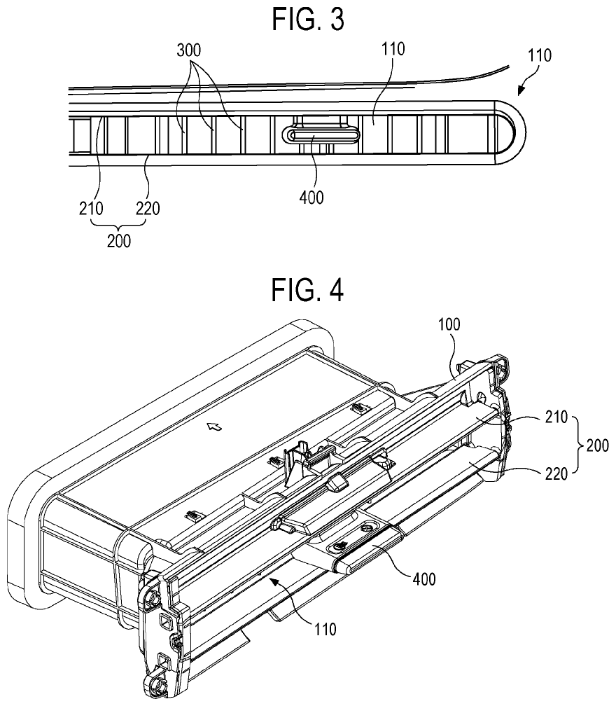

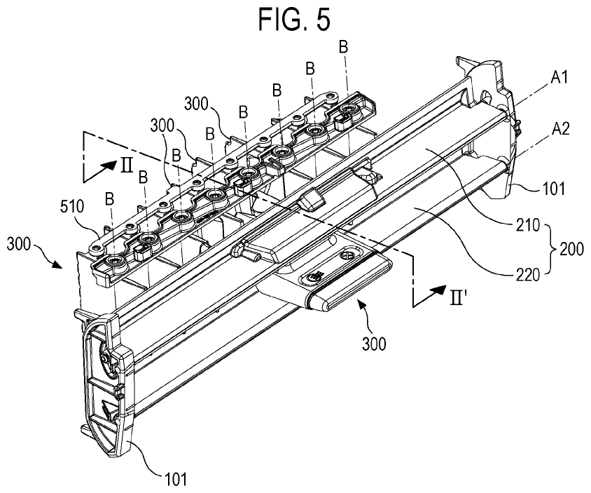

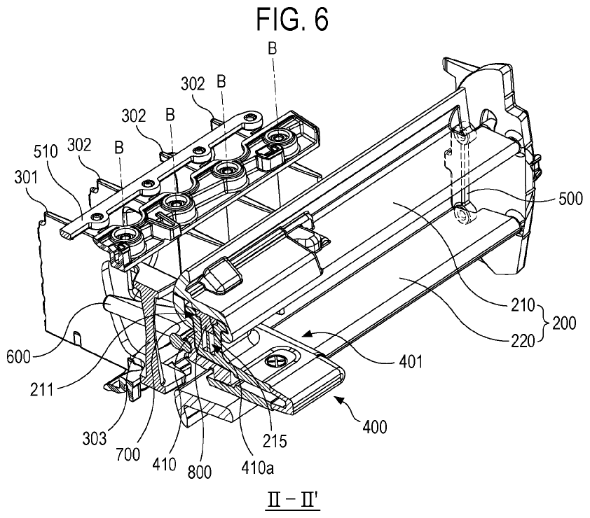

FIG. 3 is a front view of an air vent of a car according to an embodiment of the present disclosure. FIG. 4 is a perspective view of the air vent of a car according to an embodiment of the present disclosure. FIG. 5 shows an internal configuration of a housing of the air vent of a car shown in FIG. 4. FIG. 6 is a cross-sectional perspective view of the air vent of a car taken along line II-II′ in FIG. 5.

Referring to FIGS. 3 to 5, the air vent of a car (hereinafter referred to as “air vent”) according to an embodiment includes a horizontal blade 200 installed at a discharge port 110 of a housing 100, and a plurality of vertical blades 300 arranged at the rear of the horizontal blade 200.

The horizontal blade 200 may include an upper horizontal blade 210 and a lower horizontal blade 220. The upper horizontal blade 210 and the lower horizontal blade 220 extend parallel to each other in a longitudinal direction.

The horizontal blade 200 is rotatably coupled to the housing 100. The upper horizontal blade 210 and the lower horizontal blade 220 extend in the longitudinal direction (or a horizontal direction) and rotate with respect to the housing 100 about rotation axes A1 and A2, which are parallel to the longitudinal direction. As the upper horizontal blade 210 and the lower horizontal blade 220 rotate, a wind direction can be adjusted upward or downward.

The horizontal blade 200 may be supported by a side support 101. The side support 101 may be defined as a portion of the housing 100 or may be a separate member coupled to the housing 100. The upper horizontal blade 210 and the lower horizontal blade 220 are coupled to the side support 101 so as to be rotatable with respect to the side support 101 about the rotation axes A1 and A2, respectively. When the upper horizontal blade 210 and the lower horizontal blade 220 rotate, the rear ends (i.e., the tail portions) of the upper horizontal blade 210 and the lower horizontal blade 220 are moved up and down.

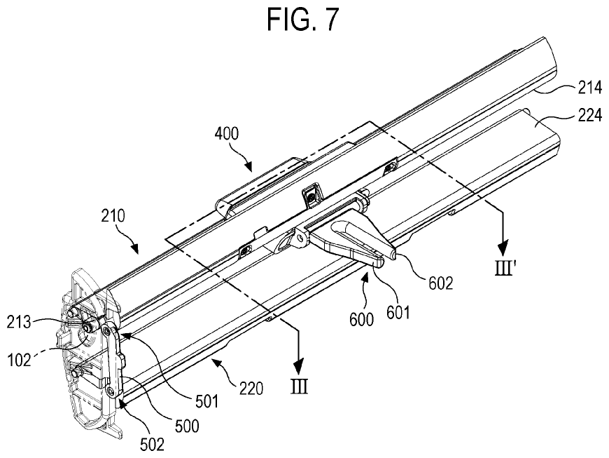

Referring to FIG. 7, the upper horizontal blade 210 includes a protrusion 213 provided at one end in the longitudinal direction, and the side support 101 may define a guide groove 102 configured to accommodate the protrusion 213 and extending in an arc shape. The guide groove 102 may limit a rotation range of the upper horizontal blade 210 by limiting a movement range of the protrusion 213.

The upper horizontal blade 210 and the lower horizontal blade 220 rotate in association with each other. When the upper horizontal blade 210 rotates in one direction by the adjustment knob 400, the lower horizontal blade 220 may also rotate in the same direction. For example, the upper horizontal blade 210 and the lower horizontal blade 220 may rotate so that a lower surface 214 of the upper horizontal blade 210 and an upper surface 224 of the lower horizontal blade 220 always face each other.

Referring to FIGS. 6 and 7, the associated movements of the upper horizontal blade 210 and the lower horizontal blade 220 may be implemented by a first link 500. The first link 500 is rotatably coupled to the upper horizontal blade 210 and the lower horizontal blade 220. One end 501 of the first link 500 is connected to a longitudinal end of the upper horizontal blade 210, and the other end 502 thereof is connected to a longitudinal end of the lower horizontal blade 220.

A plurality of vertical blades 300 are rotatably coupled to the housing 100. The vertical blades 300 rotate about a vertical rotation axis B. As the vertical blades 300 rotate, the wind direction can be adjusted in a left-right direction.

The vertical blades 300 may include a main vertical blade 301 and sub vertical blades 302. For example, one of the vertical blades 300 may be the main vertical blade 301 and the remaining vertical blades 300 may be the sub vertical blades 302. The main vertical blade 301 is moved by receiving a force directly from the adjustment knob 400, and the sub vertical blades 302 are connected to the main vertical blade 301 by a second link 510 so as to move together with the main vertical blade 301. When one vertical blade (e.g., the main vertical blade) moves, the remaining vertical blades may also rotate at the same angle by the second link 510. For example, the vertical blades 300 may rotate while maintaining parallel postures to each other.

The air vent includes an adjustment knob 400 configured to adjust directions of the horizontal blade 200 and the vertical blades 300. The adjustment knob 400 is coupled to the upper horizontal blade 210. When the adjustment knob 400 is moved up or down, the upper horizontal blade 210 rotates upward or downward, and the lower horizontal blade 220 also rotates together with the upper horizontal blade 210 by being linked with the upper horizontal blade 210 by the first link 500. That is, by operating the adjustment knob 400 upward or downward, the wind direction can be adjusted upward or downward.

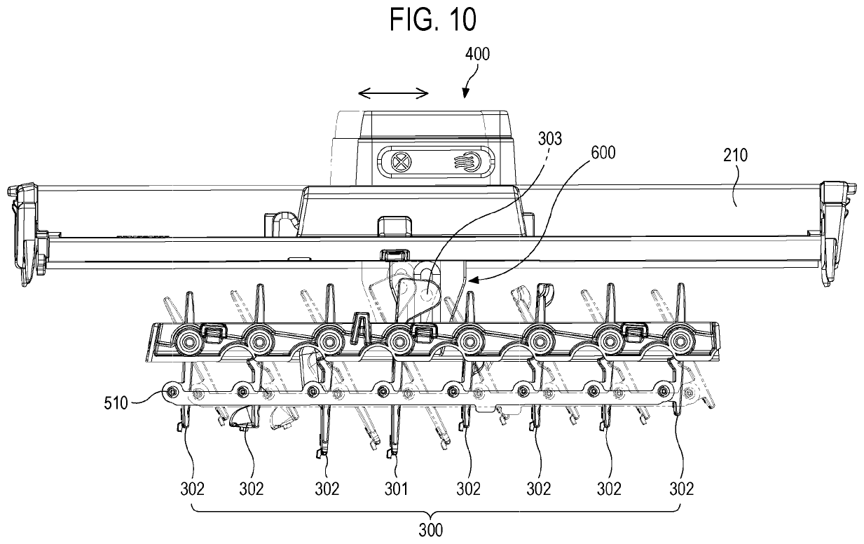

The adjustment knob 400 is coupled to the horizontal blade 200 so as to be movable in the horizontal direction. As the adjustment knob 400 moves in the horizontal direction, the vertical blades 300 are rotated so that the wind direction can be adjusted in the left-right direction. Referring to FIGS. 6 to 10, a rotation bar 600 is coupled to the adjustment knob 400. The rotation bar 600 can rotate the main vertical blade 301 among the plurality of vertical blades 300 to the left and right by moving in the left-right direction together with the adjustment knob 400. For example, the main vertical blade 301 includes a pillar 303 extending in the vertical direction, and the rotation bar 600 includes a pair of levers 601 and 602 passing through the left and right sides of the pillar 303 of the main vertical blade 301. As the adjustment knob 400 moves in the horizontal direction, the pair of levers 601 and 602 push the pillar 303 of the main vertical blade 301 to the left or right. Accordingly, the main vertical blade 301 can rotate in the left-right direction.

The adjustment knob 400 may include a body 401 and an insertion portion 410 extending upward from the body 401. The upper horizontal blade 210 may include an insertion groove 211 that accommodates a portion of the insertion portion 410. A portion of the insertion portion 410 is inserted into the upper horizontal blade 210 and can slide in the horizontal direction along the insertion groove 211. The insertion groove 211 may be configured, for example, beneath a central portion in the longitudinal direction of the upper horizontal blade 210.

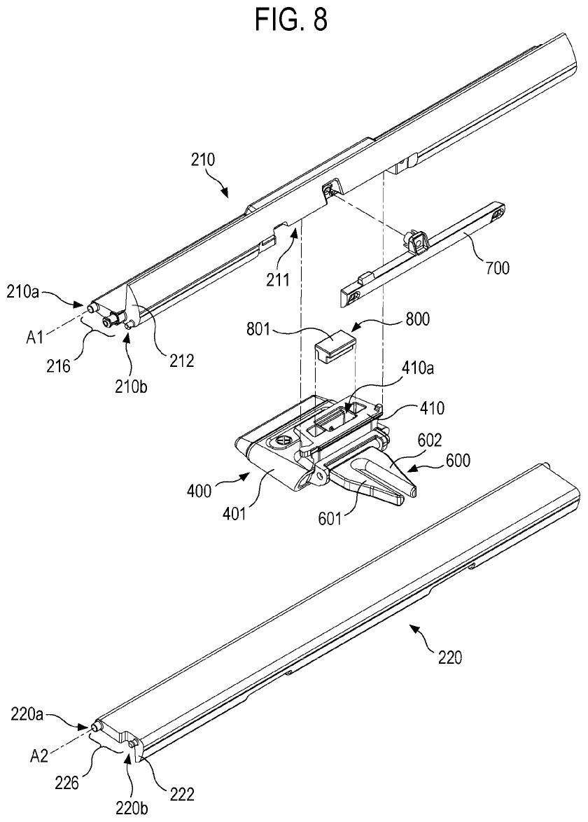

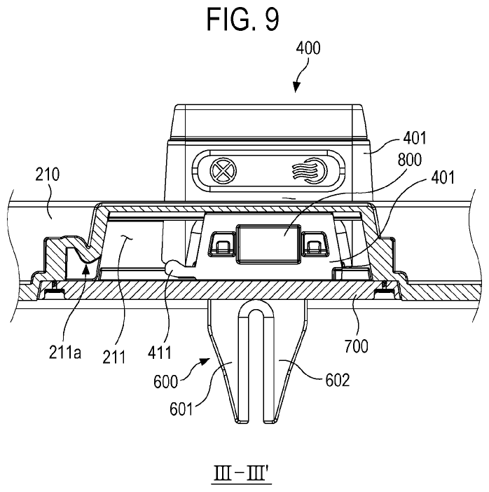

Referring to FIGS. 8 and 9, the insertion portion 410 includes a locking hook 411, and the upper horizontal blade 210 may include a locking protrusion 211a to which the locking hook 411 can be locked. The locking hook 411 may be located at one end of the insertion portion 410 in the horizontal direction, and the locking protrusion 211a may be located at one end of the insertion groove 211. When the insertion portion 410 of the adjustment knob 400 moves to the one end of the insertion groove 211, the locking hook 411 is locked to the locking protrusion 211a.

When the locking hook 411 is being locked to the locking protrusion 211a, or when the locking hook 411 is being unlocked from the locking protrusion 211a (i.e., when the locking hook 411 and the locking protrusion 211a interfere with each other), the locking hook 411 is elastically deformed to press a surface of the locking protrusion 211a, thereby increasing a friction force due to the relative movement between the locking hook 411 and the locking protrusion 211a. Accordingly, a resistance force when the locking hook 411 and the locking protrusion 211a interfere with each other is greater than a resistance force when the locking hook 411 and the locking protrusion 211a do not interfere with each other.

When the adjustment knob 400 is manipulated so that the locking hook 411 of the adjustment knob 400 is locked to the locking protrusion 211a, the plurality of vertical blades 130 close a flow path inside the housing 100. Since the locking hook 411 is locked to the locking protrusion 211a in a state in which the flow path is closed, it is possible to prevent the flow path from being unintentionally opened to discharge air through the flow path due to an outer interference such as a vibration of the vehicle.

The air vent may include a vane bracket 700 that prevents the insertion portion 410 from being separated from the upper horizontal blade 210. After the insertion portion 410 is inserted into the insertion groove 211, the vane bracket 700 is coupled to the upper horizontal blade 210 to cover the insertion groove 211 from the rear of the insertion groove 211.

Referring to FIGS. 6 and 8, an elastic body 800 may be coupled to the insertion portion 410 of the adjustment knob 400. The insertion portion 410 includes an accommodation groove 410a opened upward. An elastic body 800 is inserted into the accommodation groove 410a. When the insertion portion 410 is assembled into the insertion groove 211, an upper surface 801 of the elastic body 800 contacts a surface that defines a portion of the insertion groove 211. For example, the upper surface 801 of the elastic body 800 may contact a ceiling surface 215 of the insertion groove 211. The elastic body 800 may be configured to be pressed by the ceiling surface 215 of the insertion groove 211 when the insertion portion 410 is inserted into the insertion groove 211. Accordingly, while the insertion portion 410 slides along the insertion groove 211, the upper surface 801 of the elastic body 800 can be kept in contact with the ceiling surface 215 of the insertion groove 211. This provides a relatively uniform frictional force (or resistance force) in an opposite direction when a driver or a passenger slides the adjustment knob 400, thereby allowing the adjustment knob 400 to be manipulated delicately and accurately. If the elastic body 800 is not present, the insertion portion 410 may shake in a direction other than the horizontal direction inside the insertion groove 211. As a result, the resistance force during sliding may become irregular, which makes it difficult to adjust an amount of slide as intended. The elastic body 800 may be made of an elastic material such as rubber or silicone.

In another embodiment, the elastic body 800 may be coupled to the insertion groove 211 rather than the insertion portion 410 to press an upper surface of the insertion portion 410, which makes it possible to generate a uniform resistance force when the insertion portion 410 slides within the insertion groove 211.

Referring to FIG. 8, the upper horizontal blade 210 may include an upper blade portion 216 extending from a front end 210a to a rear end 210b and an upper blocking portion 212 extending upward from the rear end 210b of the upper blade portion 216. The lower horizontal blade 220 may include a lower blade portion 226 extending from a front end 220a to a rear end 220b and a lower blocking portion 222 extending downward from the rear end of the lower blade portion 226.

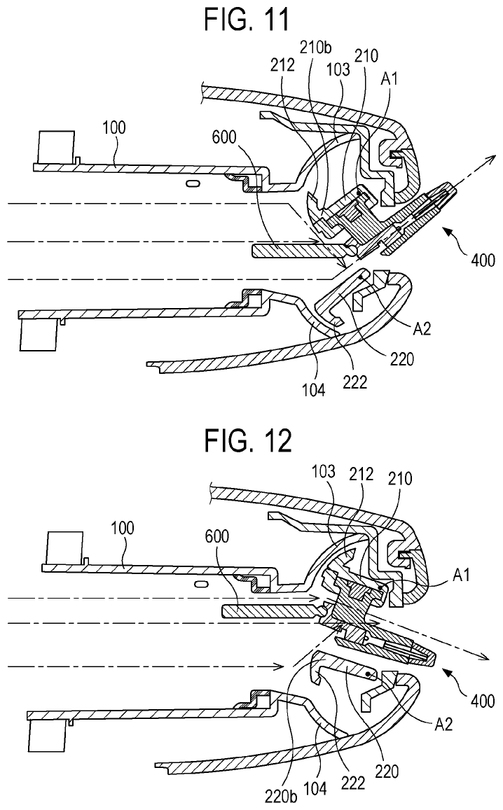

Referring to FIGS. 11 and 12, the upper blocking portion 212 may prevent a part of the wind heading toward the discharge port 110 from being introduced into a space between the upper horizontal blade 210 and an upper wall 103 of the housing 100, or may minimize such a flow. When viewed in the longitudinal direction of the upper horizontal blade 210, the upper blocking portion 212 may extend in a shape of an arc having a center positioned at the rotation axis A1 of the upper horizontal blade 210. The upper wall 103 of the housing 100 may be formed to have no gap or maintain a narrow gap between the upper wall 103 of the housing 100 and the upper horizontal blade 210. Accordingly, the inflow of air between the upper blocking portion 212 and the upper wall 103 of the housing 100 is effectively reduced or prevented. For example, the upper wall 103 of the housing 100 may extend in a shape of an arc having a center positioned at the rotation axis A1 of the upper horizontal blade 210 when viewed in the longitudinal direction of the upper horizontal blade 210. In FIG. 12, the upper blocking portion 212 is spaced apart from the upper wall 103 of the housing 100 by a certain distance. However, in another embodiment, the upper blocking portion 212 may contact the upper wall 103 of the housing 100 when the upper horizontal blade 210 is rotated downwards (i.e., clockwise as in FIG. 12).

The lower blocking portion 222 may prevent a part of the wind heading toward the discharge port 110 from being introduced into a space between the lower horizontal blade 220 and a lower wall 104 of the housing 100, or may minimize such a flow. When viewed in the longitudinal direction of the lower horizontal blade 220, the lower blocking portion 222 may extend in a shape of an arc having a center positioned at the rotation axis A2 of the lower horizontal blade 220. The lower wall 104 of the housing 100 may be formed to have no gap or maintain a narrow gap between the lower wall 104 of the housing 100 and the lower horizontal blade 220. Accordingly, the inflow of air between the lower blocking portion 222 and the lower wall 104 of the housing 100 is effectively reduced or prevented. For example, the lower wall 104 of the housing 100 may extend in a shape of an arc having a center positioned at the rotation axis A2 of the lower horizontal blade 220 when viewed in the longitudinal direction of the lower horizontal blade 220. In FIG. 11, the lower blocking portion 222 is spaced apart from the lower wall 104 of the housing 100 by a predetermined distance. However, in another embodiment, the lower blocking portion 222 may contact the lower wall 104 of the housing 100 when the upper horizontal blade 210 is rotated upwards (i.e., counter-clockwise as in FIG. 11).

Referring to FIG. 11, when the adjustment knob 400 is moved upward, the rear end 210b of the upper horizontal blade 210 is moved down to increase the gap between the upper wall 103 of the housing 100 and the rear end 210b. However, since the upper blocking portion 212 extending upward from the rear end 210b covers the gap, it is possible to minimize the flow of the air into the space between the upper horizontal blade 210 and the upper wall 103 of the housing 100. In addition, since the lower blocking portion 222 of the lower horizontal blade 220 and the lower wall 104 of the housing 100 face at a narrow interval or contact, with each other, it is possible to minimize the air flow into the space between the lower blocking portion 222 and the lower wall 104 of the housing 100.

Referring to FIG. 12, when the adjustment knob 400 is moved downward, the rear end 220b of the lower horizontal blade 220 is moved up to increase a gap between the lower wall 104 of the housing 100 and the rear end 220b. However, since the upper blocking portion 212 extending upward from the rear end 210b covers the gap, it is possible to minimize the air flow into the space between the upper horizontal blade 210 and the upper wall 103 of the housing 100. In addition, since the upper blocking portion 212 of the upper horizontal blade 210 and the upper wall 103 of the housing 100 face at a narrow interval or contact, with each other, it is possible to minimize the air flow into the space between the upper blocking portion 212 and the upper wall 103 of the housing 100.

The air vent according to the embodiment, due to the upper blocking portion 212 and the lower blocking portion 222, can concentrate the wind passing through the inside of the housing 100 on the space between the upper horizontal blade 210 and the lower horizontal blade 220. Accordingly, the wind direction is predominantly affected by the upper horizontal blade 210 and the lower horizontal blade 220, and the wind direction can be effectively adjusted up and down by the upward/downward rotation of the upper horizontal blade 210 and the lower horizontal blade 220.

According to the present disclosure in some embodiments, it is possible to provide an air vent of a car capable of effectively adjusting the wind direction up and down.

While certain embodiments have been described, these embodiments have been presented by way of example only, and are not intended to limit the scope of the disclosures. Indeed, the embodiments described herein may be embodied in a variety of other forms. Furthermore, various omissions, substitutions, and changes in the form of the embodiments described herein may be made without departing from the spirit of the disclosures. The accompanying claims and their equivalents are intended to cover such forms or modifications as would fall within the scope and spirit of the disclosures.

What is claimed is:

1. An air vent of a car, comprising:
a horizontal blade installed at a discharge port of a housing and including an upper horizontal blade and a lower horizontal blade;
a link having one end coupled to a longitudinal end of the upper horizontal blade and the other end coupled to a longitudinal end of the lower horizontal blade;
a plurality of vertical blades rotatably coupled to the housing and arranged at rear of the horizontal blade;
an adjustment knob coupled to the upper horizontal blade so as to be movable in a horizontal direction; and
a rotation bar coupled to the adjustment knob and connected to the vertical blades.

2. The air vent of a car of claim 1, wherein the adjustment knob includes an insertion portion protruding upward, and the upper horizontal blade includes an insertion groove formed at a lower portion of the upper horizontal blade and accommodating the insertion portion.

3. The air vent of a car of claim 2, wherein the insertion portion includes a locking hook, and the upper horizontal blade includes a locking protrusion to which the locking hook is configured to be locked.

4. The air vent of a car of claim 2, further comprising:
a vane bracket coupled to the upper horizontal blade and configured to prevent the insertion portion from being separated from the insertion groove.

5. The air vent of a car of claim 1, wherein the upper horizontal blade includes an upper blade portion extending from a front end of the upper horizontal blade to a rear end of the upper horizontal blade, and an upper blocking portion extending upward from the rear end of the upper blade portion, and
wherein the lower horizontal blade includes a lower blade portion extending from a front end of the lower horizontal blade to a rear end of the lower horizontal blade, and a lower blocking portion extending downward from the rear end of the lower blade portion.

6. The air vent of a car of claim 1, further comprising:
an elastic body formed in the insertion portion and coupled to an accommodation groove opened upward,
wherein the elastic body has an upper surface in contact with a surface defining the insertion groove.
